(19) United States
(12) Patent Application Publication
(10) Pub. No.: US 2007/0115425 A1
(43) Pub. Date: May 24, 2007

(54) Removeable sun visor magnetically connected to a pair of glasses

(76) Inventor: Mark Englebright, Lake Forest, CA (US)

Correspondence Address: Michael McEntee, Suite 100, 15802 Chemical Lane, Huntington Beach, CA, 92649, US

(21) Appl. No.: 11/555,250

(22) Filed: Oct. 31, 2006

Related U.S. Application Data
(60) Provisional application No. 60/732,913, filed on Nov. 1, 2005.

(51) Int. Cl. G02C 7/10

(52) U.S. Cl. 351/44

(57) ABSTRACT

A combination of a sun visor, magnetic material attached to the sun visor, a frame for glasses, and magnetic material attached to the frame, wherein the sun visor is magnetically held in a fixed position to the frame for glasses, and the sun visor is detachable from the frame for glasses by breaking the magnetic bond between magnetic material on the sun visor and magnetic material on the frame for glasses.

### CROSS REFERENCE TO RELATED APPLICATIONS

Applicant claims the benefit of his provisional patent application filed Nov. 1, 2005, Ser. No. 60/732/913.

### SEQUENCE LISTING OR PROGRAM

None.

### FIELD OF THE INVENTION

This invention relates to visors attached to and detachable from sunglasses, spectacles, and eyeglasses.

### BACKGROUND OF THE INVENTION

It is known to have sunglasses attach to eyeglass frames by clips. And it is known to have sunglasses attach to eye glass frames by magnets which interfit sockets, such as in Ifergan, U.S. 2005/0174530 A1. What has not been found in the prior art is a sun visor attached to glasses by means of magnetic material secured within the body of the sun visor mating with magnetic material embedded in the frame of glasses so that the sun visor is securely held in place snugly attached to the frame and thus snugly fitting against the forehead of the user. A commercially successful product in this area must meet many objectives.

One object of the invention is to include a sun visor which is especially effective in preventing light leakage between the visor and the forehead and temples of the user.

Another object of the invention is to protect the user's nose, eyes and checks from direct sunlight by locating the sun visor directly above the frame of the glasses. This configuration greatly reduces both glare and direct sunlight received by the eyes of the user through the sunglasses.

Another object of the invention is to allow great ease of coupling the sun visor to the eyeglass frame because the magnets hold the sun visor to the frame securely at the same time, the visor conformably interfits with the frame at various points to guide and align the visor to the frame, so that the magnetic materials in the visor and the frame come into close alignment. When the user drives in a car, the user can easily remove the sun visor, with one hand, and the driver then has more range of vision to see freeway signs over head.

Another object of the invention is to allow passive communication. Persons can use the invention to advertise their allegiance to sports teams by displaying a logo or text on the vertical wall above the brim of the visor. Because the visor can be interchanged with other visors, the user need only have only pair of sunglass, or eye glasses, and multiple sun visors. The sun visors are many times less expensive than the sunglasses or eye glasses. Thus, depending on the surroundings, one might have a sport team's name on the visor during the day, and then, at night, n a singles bar, one might indicate a variety of messages with a different visor. Again, the user can do this without having to change their sunglasses or eye glasses. This is particularly important if the sunglasses are prescription sunglasses. Prescription sunglasses can be quite expensive.

Another object of the invention is the sun visor helps protect the surface of the lens of the sun glasses or eye glasses from scratching when the sunglasses or eyeglasses have been removed. The sun visor keeps the glasses from rocking over onto the front surface of the glasses.

Another object of the invention is to assist in the sale of the eyeglasses or sunglasses. When a maker of a pair of glasses sells the glasses, it can include one or more sun visors as a low cost incentive to help close the sale of the glasses (or frames). Thus, a licensee of this invention may gain a major competitive advantage over competitors whose frames do not have magnetic linking with visors.

Another object of the invention is to allow less-dark sunglasses to be used by referees in soccer, and umpires in baseball. In both sports, the official policy is to discourage the use of sunglasses. But, this invention, with its combination of sun visor very close to the frame, does such a good job of reducing glare and direct sunlight, that the sunglass material can be made less dark. This, in turn, allows use of sunglasses by referees and umpires who would otherwise rely solely on a cap with a brim.

Throughout this patent application, the term glasses will be understood to include sunglasses, eyeglasses, novelty eye wear, and spectacles. The term “frame” may include the arms and hinge structure of the “glasses.”

### SUMMARY OF THE INVENTION

In one embodiment of the invention, there is a combination of a sun visor made of foamed plastic, and embedded in at least one part of that foamed plastic, there is some magnetic material. Magnetic material is placed onto, or bonded into, or clipped onto a frame for glasses. At one or more points on the glasses are attached magnetic material, or magnetizable material. The visor is magnetically held in a fixed position to the frame for glasses, and the sun visor is detachable from the frame for glasses by breaking the magnetic bond between magnetic material on the visor and magnetic material on the frame for glasses. When the user attempts to join the visor to the glasses, the visor easily attaches without close attention of the user, because there is formed in the lower portion of the visor a step which interfits with the frame closely enough that the magnetic materials of the visor and the frame become aligned. Once aligned, the magnetic force takes over and guides the visor into position, forming a secure pathway of magnetic force between the magnetic material in the frame and correspondingly located magnetic material in the visor.

The terms “visor” and “sun visor” can be understood to include visors for purposes other than just shielding from the sun. Such visors could be for shielding glare indoors, or visors for training eye motion.

### DESCRIPTION OF THE DRAWINGS

FIG. 1 is an over head perspective sketch of a typical pair of wrap around sunglasses(collectively referred to as number 1). Added to the sunglasses are three magnets, 8, 10 and 12, shown located in the upper bar of the lens frames.

FIG. 2 is an upper side perspective sketch of one kind of sun visor contemplated as the preferred embodiment.

FIG. 3 is an upper side perspective sketch of the sun visor shown in FIG. 2, except that Rib 34 is considerably higher.

FIG. 4 is a cross section view taken through FIG. 3, as shown.

FIG. 5 is a perspective view of a break out of the sun visor of FIG. 3 mated to the frame shown in FIG. 1.

### PART NUMBER GLOSSARY

1 a typical wrap around pair of sunglasses
2,3 pair of lens,
4,5 nose pads
6 bridge portion
7 frame
14 upper surface of frame
8,10,12 magnetic materials
22,24 hinge screws
18,20 arms of the glasses
30 sun visor
36,38 arm sections
26,28 temple parts
32 lower surface 32
33 magnetic material in the rib 34
34 rib of the sun visor
36,38 temple portion of sun visor
40 upper surface
42 Guide edge
44,46 neck string holes
48 adhesive surface
49 soft material

### DETAILED DESCRIPTION OF THE PREFERRED EMBODIMENT

In use by the ultimate user, the preferred embodiment includes two assemblies. The first is the sun visor, and the second is the pair of glasses onto which the sun visor is mounted. A very wide variety of pairs of glasses can be utilized to practice this invention.

Two criteria of whether a design of a pair of glasses can utilize this invention are: (1.) Does the frame of glasses have a place for one or more small magnets to be placed near the upper part of the frame and/or arms, and (2.) Can the magnets be positioned so that the magnets on the visor assembly may touch (or nearly touch) the magnets on the pair of glasses. The vast majority of glasses do meet these criteria.

FIG. 1 is a sketch of a typical wrap around pair of sunglasses (collectively referred to by numeral 1 on the drawing). FIG. 1 shows a pair of lens, 2 and 3, nose pads, 4 and 5, bridge 6, and the upper surface 14 of the frame 7. It must be emphasized that wire frame glasses (not shown), and regular plastic frame eyeglasses (not shown) can also utilize the invention. Indeed, all that is required is that means be provided to secure one or more pieces of magnetic material in the upper bar of the frame of the glasses. For example, FIG. 1 shows magnetic materials at 8, 10 and 12. Magnetic materials 10 and 12 are mounted near hinge screws 22 and 24. But, the magnetic materials could also be mounted in the arms 18 and 20 of the glasses. And, if the sun visor 30, as shown in FIGS. 2 and 3, had its own arm sections reaching back to the temple portions, 36 and 38, then the magnets, 10 and 12, could be mounted in the temple parts, 26 and 28, of the arms, 18 and 20. Likewise, just one magnet 8, mounted near the bridge portion 6 of the frame, could hold the sun visor 30. Thus the invention is very versatile and flexible in its application to existing designs of sunglasses, eye glasses, and spectacles.

FIGS. 2, 3 and 4 shows the corresponding sun visor 30 which would mate with the glasses. As one example, the magnetic material 33 in the rib 34 of the cross section of sun visor 30 would mate with the magnetic material 8 embedded over the bridge 6 of the glasses in FIG. 1. One useful feature of the sun visor 30 is that the rib 34 can be tall enough such that the visor sun shielding body, comprising lower surface 32 and upper surface 40, can be extra large, because it is stiffened by the depth of the rib 34. This permits use of very low cost material, such as plastic foam, to be utilized in making the visor body. Such plastic foam is very low density, thus resulting in a product which does not weigh down the glass frames. Rib 34 also acts as a style line and makes the product communicate a feeling of ruggedness to the customer.

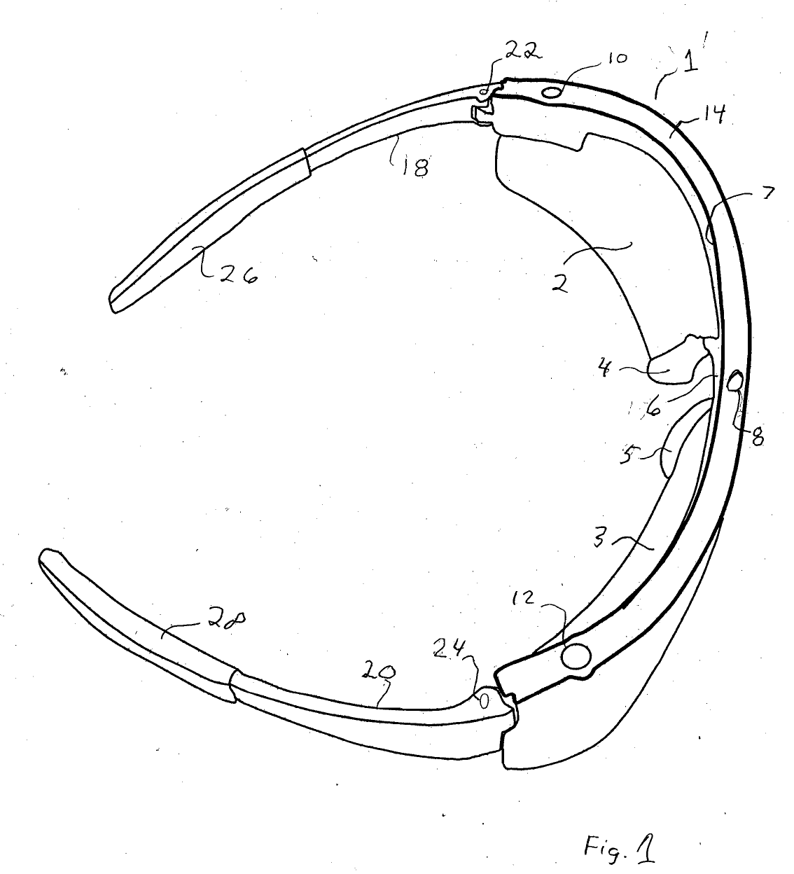

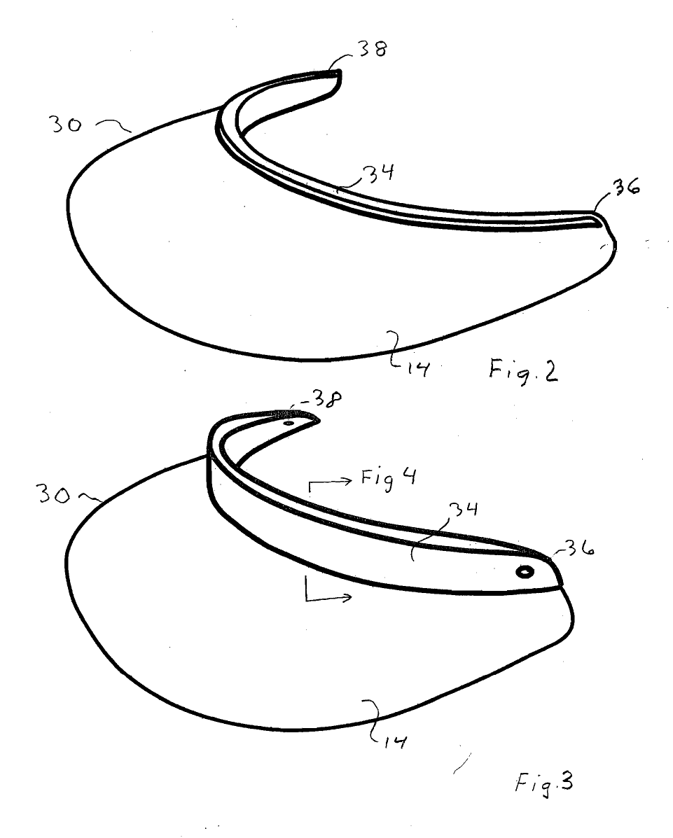

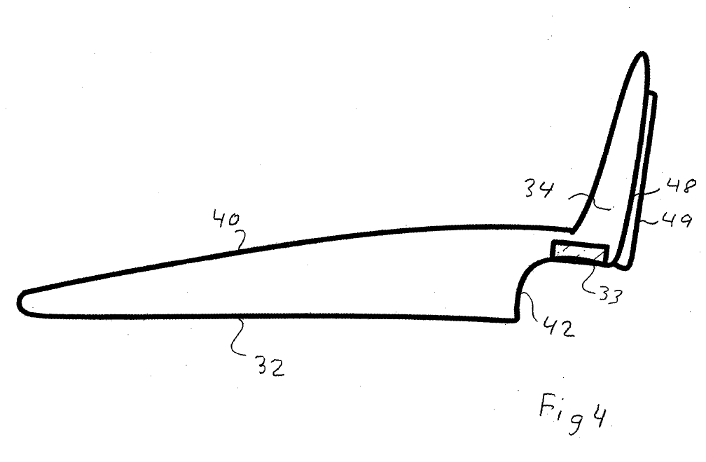

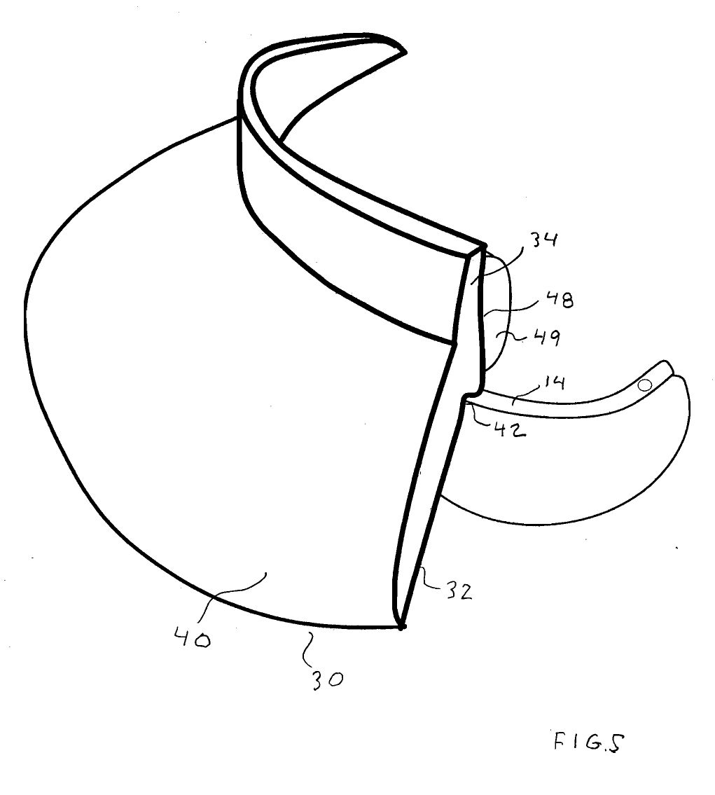

In FIG. 3, optional neck string holes, 44 and 46, are formed in rib 34. In FIG. 4, a guide edge 42, is formed by the intersection of lower surface 32 and the bottom of rib 34. The upper surface 14 of frame 7 interfits to magnetic material 33 and guide edge 42. Adhesive coated surface 48 attaches soft head-band material 49 to the rib 34. This material 49 together with rib 34 acts to greatly reduce, or totally eliminate, sunlight and glare which often intrudes in conventional and visor combinations.

FIG. 5 shows the intersection of upper bridge surface 14 with guide edge 42. For simplicity, the arm of the glasses is not shown. One objective of the invention is to allow great ease of coupling the sun visor to the eyeglass frame because the visor conformably interfits with the frame at various points to guide and align the visor to the frame, so that the magnetic materials in the visor and the frame come into close alignment. When the user drives in a car, the user can easily remove the sun visor, with one hand, and the driver then has more range of vision to see freeway signs over head. In FIG. 5, guide edge 42 just touches upper bridge surface 14, but no careful attention is required of the user to establish that alignment. The alignment is established in a second of time by trial and error, guided by 14 and 42. When the visor and glasses get close, the magnetic force takes over and guides the visor into tight and correct alignment of the magnet(s). This ease of use is in sharp contrast to the prior art disclosures calling for intersecting mechanically clips into holes, and other steps which require precise alignment and require that the visor not bend or go vary in form, fit or function.

By contrast, the present invention allows reliable, rugged connections even though the visor may be made of foamed or easily deformed material, and even though the glasses may have been bent or somewhat twisted.

Preferably, an industry or manufacturers product line would establish consistent distances and locations for the magnetic material on the frame, which distances and locations would be matched by visors, so that a wide variety of visors might be interchangeable with a wide range of frames.

Although the invention has been described with reference to certain specific embodiments, various modifications to those embodiments will be apparent to those skilled in the art without departing from the spirit and scope of the invention as outlined in the claims which follow, and therefor the above descriptions do not limit the true scope of the claims.

I claim:

1. The combination of a visor and magnetic material.

2. The combination of claim 1 further comprising a frame for glasses, and magnetic material associated with the frame, wherein the visor is magnetically held in a fixed position to the frame for glasses, and the visor is detachable from the frame for glasses by breaking the magnetic bond between magnetic material on the sun visor and magnetic material on the frame for glasses.

3. The combination of claim 1 further comprising an upper bridge surface 14 with a guide edge 42.

4. The combination of claim 1 further comprising an adhesive coated surface 48 which attaches a soft head-band material 49 to the rib 34.
